(19) United States
(12) Patent Application Publication
(10) Pub. No.: US 2010/0174021 A1
(43) Pub. Date: Jul. 8, 2010

(54) Three-dimensionally shaped interpenetrating network hydrogels

(76) Inventors: Philip Huie, JR., Cupertino, CA (US); Dale Jon Waters, Stanford, CA (US); Curtis W. Frank, Cupertino, CA (US); Christopher N. Ta, Los Altos, CA (US); Ariane C. Tom, Riverside, CA (US)

Correspondence Address: LUMEN PATENT FIRM, 350 Cambridge Avenue, Suite 100, PALO ALTO, CA, 94306, US

(21) Appl. No.: 12/653,293

(22) Filed: Dec. 11, 2009

Related U.S. Application Data
(63) Continuation-in-part of application No. 12/070,336, filed on Feb. 15, 2008.
(60) Provisional application No. 61/201,711, filed on Dec. 11, 2008.
(60) Provisional application No. 61/270,546, filed on Jul. 8, 2009.

(51) Int. Cl. C08K 5/06; C08J 3/00

(52) U.S. Cl. 524/377

(57) ABSTRACT

Three-dimensionally (3-D) shaped interpenetrating double network (IPN) hydrogel based on a first network and a second network are provided. The 3-D shape is characterized by a non-uniform distribution of the second network (e.g. carboxylic acid groups) when in hydrated state. The 3-D shape can further be characterized by changes in the radius of curvature of the shape. The 3-D IPN hydrogel is created by applying a non-uniform illumination pattern to polymerize the second network of monomers within a layer of a first network. In hydrated state, the second network causes a swelling force that is resisted by the first network. The non-uniformal distribution of the second network with the first network is responsible for the 3-D of the resulting IPN. The invention can find use in ophthalmic applications as well as non-ophthalmic applications.

### CROSS-REFERENCE TO RELATED APPLICATIONS

This application claims priority from U.S. Provisional Patent Applications 61/201,711 filed Dec. 11, 2008 and 61/270,546 filed Jul. 8, 2009, which are both incorporated herein by reference. This application is a continuation-in-part of U.S. Non-Provisional application Ser. No. 12/070,336 filed Feb. 15, 2008, which is incorporated herein by reference for all that it teaches.

### STATEMENT OF GOVERNMENT SPONSORED SUPPORT

This invention was made with Government support under contract RO1 EY016987-01A1 awarded by National Institutes of Health (NIH). The Government has certain rights in this invention.

### FIELD OF THE INVENTION

The present invention relates to interpenetrating network hydrogels with three-dimensional shapes, geometries and patterns. The present invention also relates to interpenetrating network hydrogels with three-dimensional shapes, geometries and patterns for ophthalmic applications such as artificial corneas, cornea inlays, cornea onlays, and contact lenses.

### BACKGROUND OF THE INVENTION

Interpenetrating network (IPN) hydrogels have two or more individually chemically crosslinked networks of water-soluble polymers that swell in the presence of water, yet cannot be fully separated from each other, due to the presence of physical entanglements between the networks. These hydrogels are of particular interest because they have been shown to have order-of-magnitude increases in initial elastic modulus and fracture strength compared to individual networks of each component. This increase in mechanical properties is observed despite the hydrogel maintaining a high water content (e.g. 80-90 wt. %).

The method to create IPN hydrogels involves a two-step sequential polymerization. In the first step, monomers are polymerized to form a single network hydrogel. In the second step, the first network is swollen with a second monomer solution, which is subsequently polymerized. This will form a second network interpenetrating the first polymer network. Depending upon the preparation conditions and the nature of the specific polymers, it is likely that the hydrogel will swell and expand volumetrically after each step in this process.

IPN hydrogels are merely flat sheets which have to be molded to create a three-dimensionally curved IPN hydrogel. One method to form a three-dimensional curved single network hydrogel is to perform the polymerization of the hydrogel in a curved mold. However, to create high mechanical strength and high water content IPN hydrogels, a two-step polymerization procedure is required. A difficulty associated with the molding of IPN hydrogels is that a two-step molding process is required due to the swelling that occurs after each polymerization step. The molds must be designed precisely so that the first network hydrogel will fit into the second mold and the second mold will generate the desired final shape upon hydrogel swelling.

A procedure involving one or more molds is cumbersome and is difficult to realize in a practical high throughput manufacturing setting. Accordingly, there is a need in the art to develop new techniques to make three-dimensionally shaped IPN hydrogels where one could control the curvature or 3-D geometry/shape of the IPN hydrogel. The present invention addresses this need.

### SUMMARY OF THE INVENTION

The present invention provides a three-dimensionally shaped interpenetrating double network hydrogel based on a first network and a second network. The three-dimensional shape is characterized by changes in the radius of curvature of the shape. These changes in the radius of curvature correspond to a non-uniform distribution of the second network when in hydrated state. In one embodiment, the three-dimensional shape corresponds to a degree of non-uniformity of carboxylic acids in the second network. In another embodiment, the changes in the radius of curvature if the three-dimensional shape are either increasing or decreasing in a continuous fashion corresponding to the changes in distribution of the second network.

The three-dimensional shaped interpenetrating double network hydrogel is created by applying a non-uniform illumination pattern to polymerize monomers as the second network within a layer of a first network. Depending on the type of three-dimensional shape, the non-uniform illumination pattern could be applied to at least one side of the layer of the first network. Different illumination patterns or sources could be used. Some examples are e.g. a non-uniform photomask, a gradient photomask, or a radially symmetric gradient photomask. After the second network is physically interpenetrating with the first network, the second network is hydrated. The hydration causes a swelling force of the second network that is resisted by the first network. Since the second network is distributed non-uniformally with the first network a three-dimensional shape is formed corresponding to the non-uniform distribution of the second network.

In one example, an entangled first network of poly(ethylene)glycol macromonomers was used. The poly(ethylene)glycol macromonomers are linked to each other through end-groups of the poly(ethylene)glycol macromonomers. The entangled first network is physically interpenetrated with a second network, whereby the second network is based on crosslinked poly(acrylic) acids. As a skilled artisan would appreciate, the invention is not limited to these type of networks as long as the second network is UV polymerizable and hydrophillic, i.e. capable of introducing a swelling force when physically entangled within a first network.

One advantage of the invention is that the step of non-uniform illumination can be performed without the use of one or more molds for the purposes of making the three-dimensionally shaped interpenetrating double network hydrogel. Another advantage is that the process of making these three-dimensionally shaped interpenetrating double network hydrogels is tunable, simple in design and easily scalable to manufacture in large quantities, and a low equipment cost.

Devices resulting from this invention can be used in a variety of applications, such as, but not limited to, ophthalmic applications, including artificial cornea, cornea onlay or overlay, full thickness cornea as well as non-ophthalmic applications including sensors, optical sensors, or sensors that use an array or patterned array of lenses.

### BRIEF DESCRIPTION OF THE DRAWINGS

FIGS. 1-2 show schematic examples of a three-dimensionally shaped interpenetrating double network hydrogel 100 including the non-uniform distribution of a second network 120 with hydrogel 100 according to an embodiment of the present invention.

FIG. 3 shows a photograph of an example a three-dimensionally shaped interpenetrating double network hydrogel 100′ according to an embodiment the present invention. The photograph with hydrogel 100′ corresponds to the schematic example in FIGS. 1-2 (100, 110, 120 corresponds to 100′, 110′, 120′ respectively).

FIGS. 4A-D show four examples according to an embodiment of the invention of measurements of the toluidine blue staining demonstrating the non-uniform distribution of the carboxylic acid groups of the second network in hydrogel 100′ taken at the four locations shown in FIG. 3 (0 degrees, 45 degress, 90 degress, 106 degrees).

FIG. 5A shows examples according to an embodiment of the present invention of different three-dimensionally shaped interpenetrating double network hydrogels resulting from variations in the illumination exposure time.

FIGS. 5B-D show each a three-dimensionally shaped interpenetrating double network hydrogel with dark areas representing the toluidine blue stain areas representing the distribution of the carboxylic acid groups of the second network in the respective hydrogel.

FIG. 6A-C show examples of the method of making a three-dimensionally shaped interpenetrating double network hydrogel using one photomask according to an embodiment of the present invention.

FIG. 7 shows an example of the method of making a three-dimensionally shaped interpenetrating double network hydrogel using two photomasks according to an embodiment of the present invention.

FIGS. 8A-E show examples of different types of 3-D shapes that result from the type of non-uniform illumination according to an embodiment of the present invention.

FIGS. 9A-B show examples of a single photomask or a photmask with multiple gradients according to an embodiment of the present invention.

FIGS. 10-13 show photographic examples of three-dimensionally shaped interpenetrating double network (PEG/PAA) hydrogels according to embodiments of the present invention.

### DETAILED DESCRIPTION

The three-dimensionally (3-D) shaped interpenetrating double network hydrogels according to the present invention require a two-step polymerization and rely on the IPN hydrogel swelling after the second polymerization step to create the 3-D shape. The invention does not require any molding apparatus or similar devices to introduce a 3-D shape or 3-D surface curvature. Instead, the invention makes use of a non-uniform light (UV) exposure/illumination in the second polymerization step. The 3-D shapes can in fact be generated from initially flat precursors or sheet of the first network. The process of the invention enables the control of creating 3-D shaped IPN hydrogels from a single sheet. One could control, for example, the curvature of the IPN on one or more than one sides of the IPN.

In one embodiment, a first network is prepared through, for example, methods described in U.S. Non-Provisional application Ser. No. 12/070,336 filed on Feb. 15, 2008. The first network is usually created through thermal-initiated or photo-initiated free radical polymerization. The polymerization of the second monomers is performed via a photo-initiated polymerization using a non-uniform UV exposure/illumination, e.g a non-uniform photomask.

The polymerization of the second network into the first network depends on the the UV exposure, which could be controlled by various factors such as intensity, time, etc. The idea of the non-uniform photomask is to vary the UV exposure along the sheet during the second polymerization step to control the degree of polymerization of the second network within the first network. In other words, regions of the sheet with a UV exposure sufficient to fully polymerize the second network will result in a complete IPN across the thickness of the sheet (i.e. in the direction of the exposure). Regions of the sheet with UV exposure below the threshold of being sufficient to fully polymerize the second network will not create a complete IPN or create a sub-complete IPN across the thickness of the sheet. In general, variations of the UV exposure in the second polymerization step result in variations of the degree to which the second network was polymerized to the point that regions with no UV exposure will not polymerize and remain a single network.

When in a hydrated state, the forces driving the swelling of the second network will be non-uniform over the regions where the non-uniform photomask was used. Regions with a more complete second network will exert a stronger swelling force than regions with more ‘defects’ in the second network (‘defects’ refer to the lack/absence of polymerization of the second network). This differential swelling force will be resisted by a uniform resistance to the swelling from the first network. This will result in a 3-D shaped IPN hydrogel structure whereby the 3-D shape corresponds to the non-uniform exposure pattern and the resulting non-uniform distribution of the second network.

The structural aspects corresponding to the resulting 3-D shaped IPN hydrogel of the present invention can be assessed or quantified through applicable procedures and methods. For example, but not limited to:
A. The 3-D shaped IPN hydrogel can be characterized by changes in the radius of curvature, whereby the changes in radius of curvature correspond to a non-uniform distribution of the second network when in hydrated state.
B. The 3-D shaped IPN hydrogel can be characterized by a non-uniform distribution of carboxylic acid groups resulting from the non-uniform exposure. The distribution of carboxylic acid groups can be measured via staining of the carboxylic side chains. At least the following methods could be used:
   1. 1-pyrenyldiazomethane (PDAM)—a direct carboxylic acid modification that is fluorescent.
   2. 1-ethyl-3-(3-dimethylaminopropyl)carbodiimide, hydrochloride (EDAC) (linker) followed by a reaction with 4′-(aminomethyl)fluorescein, HCl (reporter) two-step method.
   3. A positively charged dye, such as toluidine blue, could be used to associate with ionized carboxylic acid groups through electrostatic interactions and could be used to visualize a carboxylic acid gradient in the 3-D shaped IPN hydrogel. The use of toluidine blue detects the quantitative changes in carboxylic acid groups in the 3-D IPN hydrogel. The examples provided herein used 1000 mL PBS to 0.5 g toluidine blue. However, other procedures of using toluidine blue could be used to detect quantitative changes in carboxylic acid groups in the 3-D IPN hydrogel.
   4. The 3-D shape could be scanned to determine whether there was a quantitative change of carboxylic acid across the 3-D shape. A change in the concentration of carboxylic acid will correspond to the 3-D shape.
B. The 3-D shaped IPN hydrogel can also be characterized by a non-uniform molecular structure of the second network of the IPN hydrogel, which, for example, can be measured via small angle X-ray scattering patterns along the gradient or non-uniform exposure.

This invention has been demonstrated for an IPN hydrogel having a poly(ethylene glycol) (PEG) first network interpenetrated with a poly(acrylic acid) (PAA) second network (See U.S. Non-Provisional application Ser. No. 12/070,336 filed on Feb. 15, 2008 for material and process details of the first network, second network and flat-sheet IPNs). However, the invention is not limited to the choice of these polymers or hydrogels. In general, any hydrogel network could be used with the condition that the second network is capable of applying a swelling force, within a first network, when it is hydrated after UV exposure/polymerization. The magnitude of this swelling force of the second network and resistant force of the first network will control the curvature or 3-D shape generated in the IPN hydrogel.

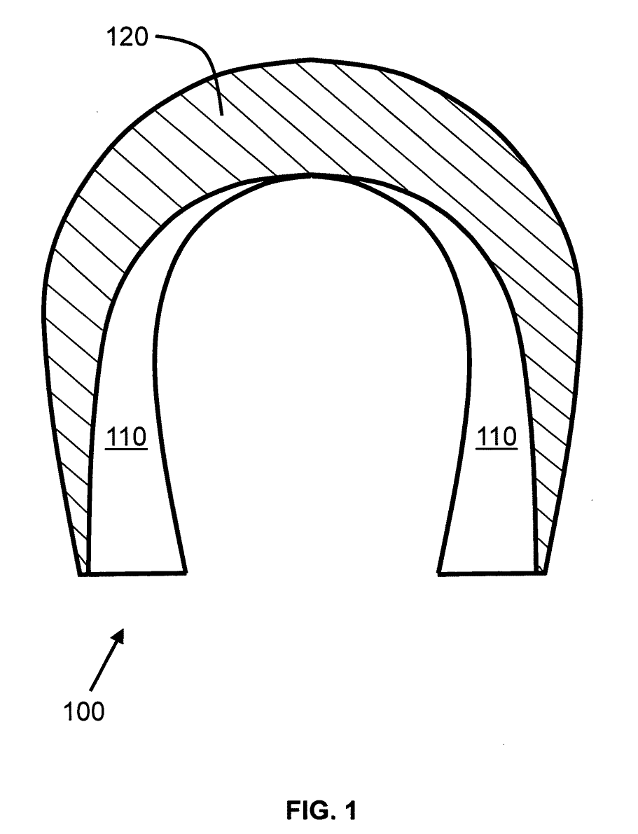

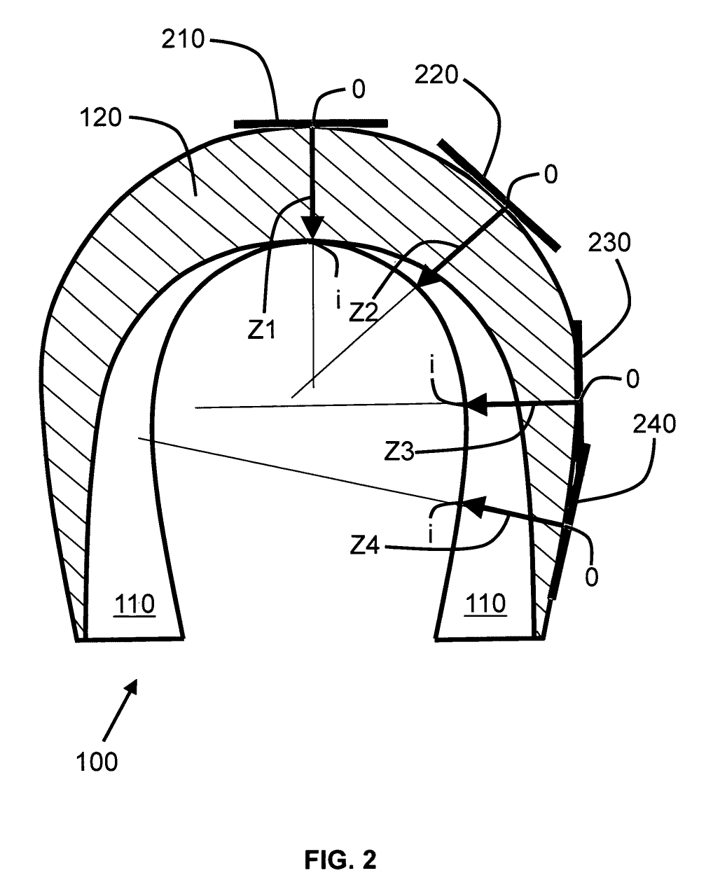

FIGS. 1 and 2 show an example of a 3-D shaped IPN hydrogel 100 resulting from the two-step polymerization as described above with a gradient (non-uniform) photomask used in the second step. The entire area of 100 (i.e. 110 and 120) contains the first network. However, only the dashed area 120 contains the polymerized second network which varies in a non-uniform manner over the IPN (see e.g. the Z-axes (Z1, Z2, Z3, Z4) through the thickness of IPN 100 in FIG. 2). The dashed area 120 represents the result of staining the IPN with e.g. toluidine blue to identify the carboxylic acid groups of the polymerized second network.

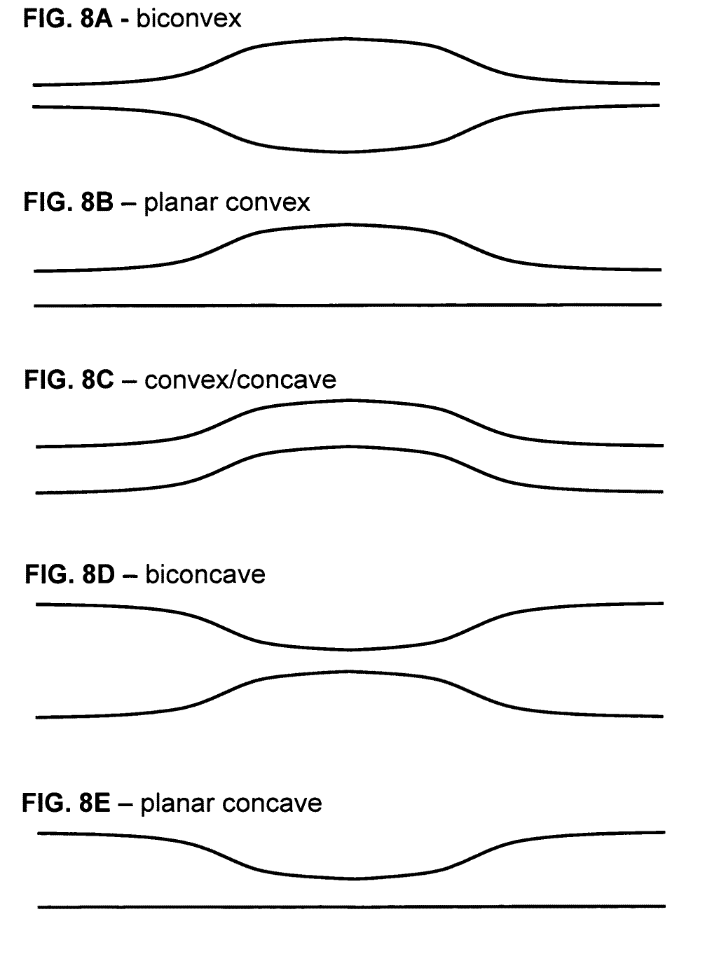

FIG. 2 shows the changes in the radius of curvature, whereby the changes in radius of curvature correspond to a non-uniform distribution of the second network (when in hydrated state). The radius of curvature is illustrated by the projection lines following the Z-axes (Z1, Z2, Z3, Z4) through the thickness of IPN 100, whereby the projection lines or radius line starts at the origin of the respective Z-axis. In this embodiment, the radius of curvature increases when going from the region of the IPN 100 near Z1 towards the lateral/radial regions (i.e. in the direction of Z4 or passed Z4 towards the side-ends of IPN 100). As one would appreciate, the radius of curvature could also decrease depending on the non-uniform distribution of the second network (see e.g. FIG. 8A-E). One could also characterize the radius of curvature as either continuously increasing or decreasing in correspondence with the changes in distribution of the second network.

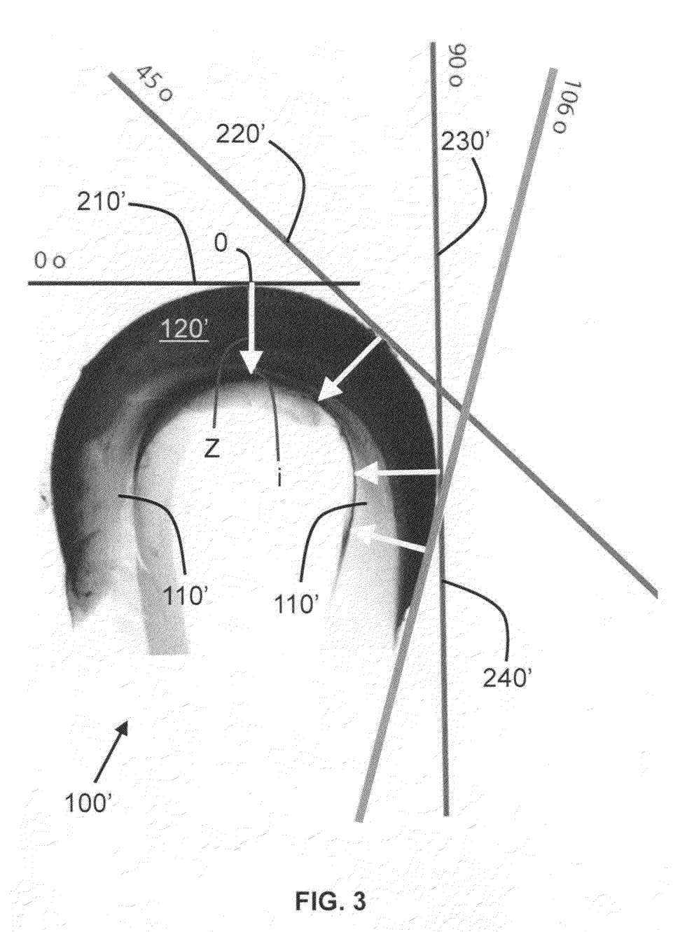

FIG. 3 is an actual result example of a PEG/PAA IPN hydrogel 100′ including the toluidine blue stained area 120′, which appears black in FIG. 3 compared to corresponding dashed area 120 in FIGS. 1-2. Also shown in FIG. 3 is the slope along the 3-D shaped IPN at various locations which correspond the the locations of FIGS. 1 and 2 (i.e. 210 is similar to 210′, 220 is similar to 220′, 230 is similar to 230′, and 240 is similar to 240′. Also indicated are the same Z-axes. O stands for outer, which is the location at the outer surface of the IPN at the origin of each Z-axes, and i stands for inner, which is the location at the inner surface of the IPN at the end of the arrow head of each Z-axes.

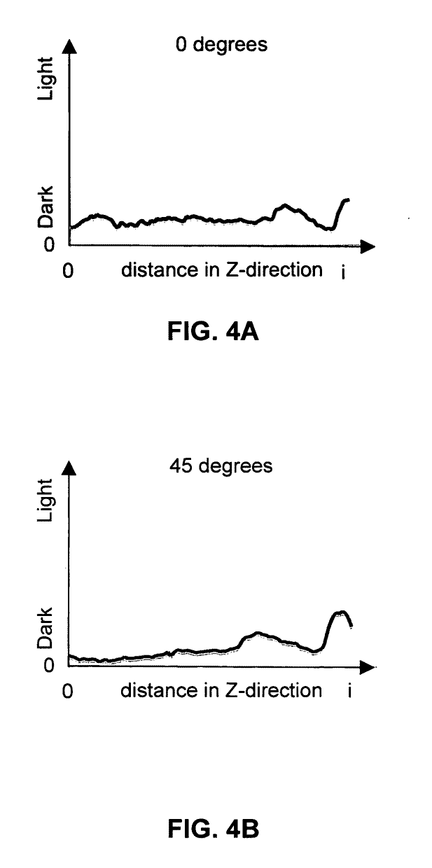

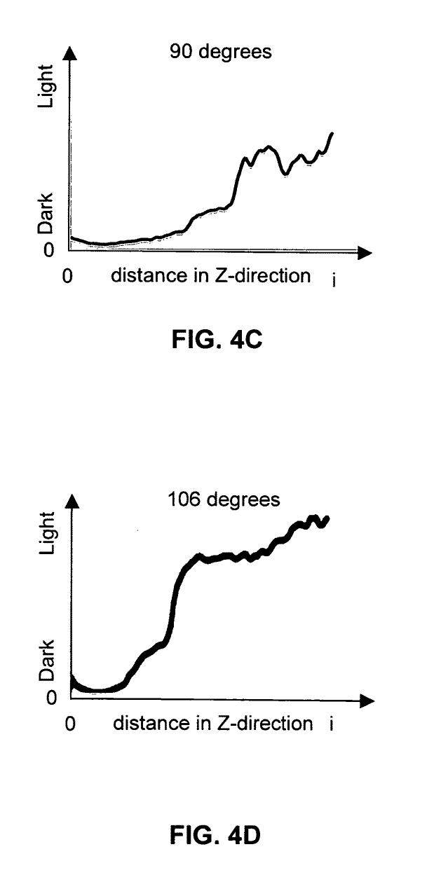

FIGS. 4A-4D demonstrate quantifications of the toluidine blue stain of the PEG/PAA IPN at the different Z-axes in FIG. 3. The x-axis represent the line between o and i along each Z-axis. The y-axis represents the toluidine blue stain where zero is the darkest value, i.e. polymerized second network/highest distribution of carboxylic acid groups. Increasing y-axis represents regions of the IPN with fewer or no polymerized second network/lower or no distribution of carboxylic acid groups. FIG. 4A shows a darker value across the Z-axis (in between o and i) indicating a polymerized second network. FIG. 4B shows a darker value for the most part across the Z-axis (in between o and i) indicating a polymerized second network except towards the i region where there is an increase indicating a reduction of the polymerized second network. FIG. 4C shows a darker value about ⅔ across on the Z-axis (in between o and i) indicating a polymerized second network up to about ⅔ across the Z-axis and from thereon up to the i region there is a reduction or absence of the polymerized second network. FIG. 4D shows a darker value about ⅓ across on the Z-axis (in between o and i) indicating a polymerized second network up to about ⅓ across the Z-axis and from thereon up to the i region there is a reduction or absence of the polymerized second network.

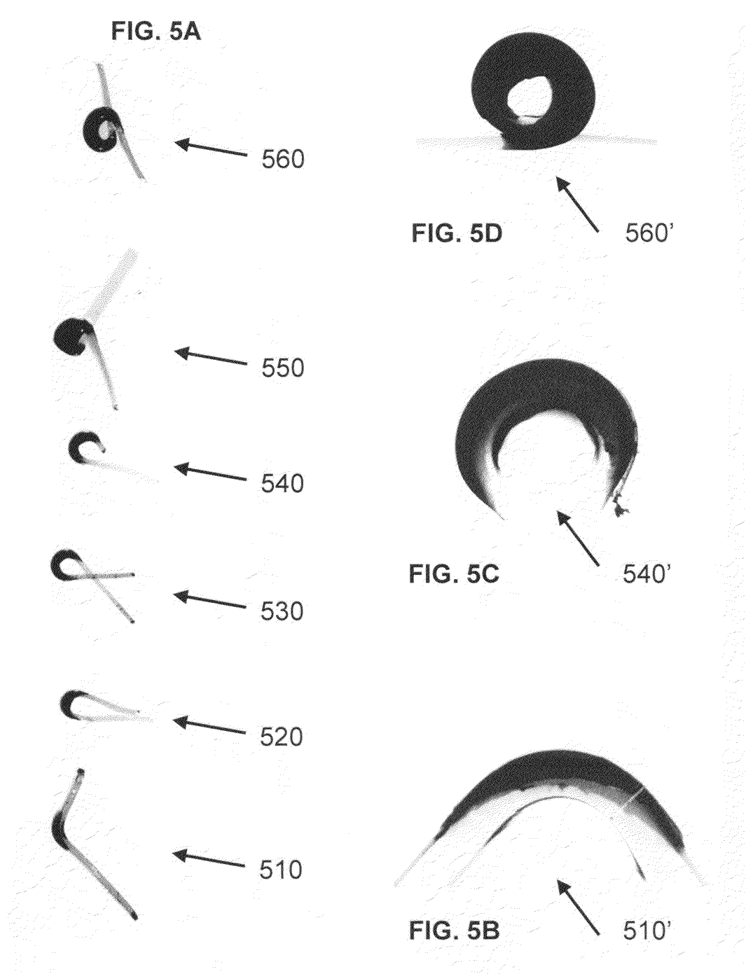

As indicated above, the degree of polymerization of the second network can be varied to generate different 3-D shaped IPNs by changing the light exposure parameters or photomask material, gradient or gradient direction. For example, a photomask with a less gradual gradient will result in a steeper curve or step in the IPN hydrogel shape. A discontinuous gradient (an abrupt change in the % transmission through the mask) will produce a step in the IPN hydrogel shape. FIG. 5A shows examples of increased UV exposure time, yet using a gradient (non-uniform) photomask for the second polymerization step. 510, 520, 530, 540, 550, 560 are the resulting IPN with a 60s, 70s 80s, 90s, 100s, 110s gaussian range exposure respectively. An increase in UV exposure time with a non-uniform photomask results in an increase of the polymerization of the second network as indicated by the results of the toluidine blue staining. FIGS. 5B-D shows the toluidine blue staining results 510′, 540′, 560′ for examples 510, 540, 560.

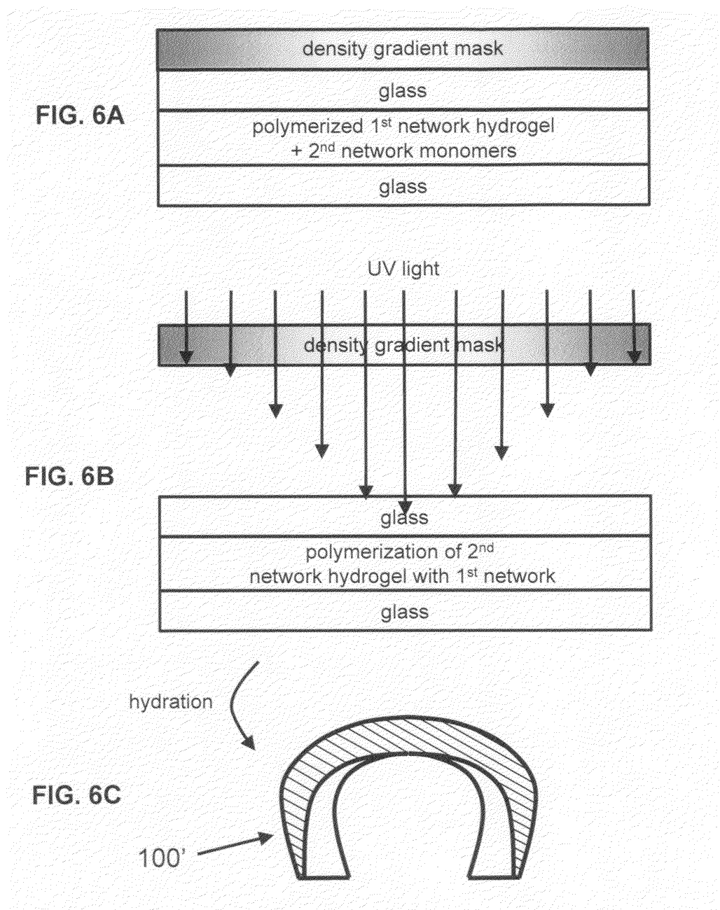

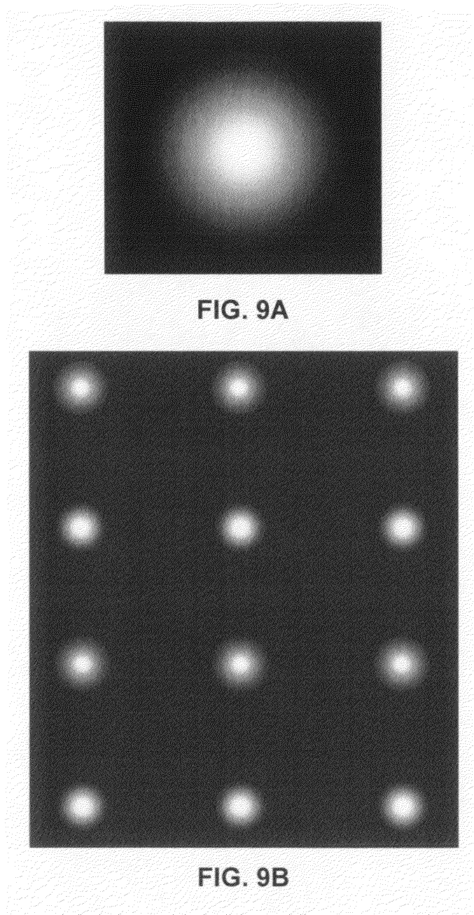

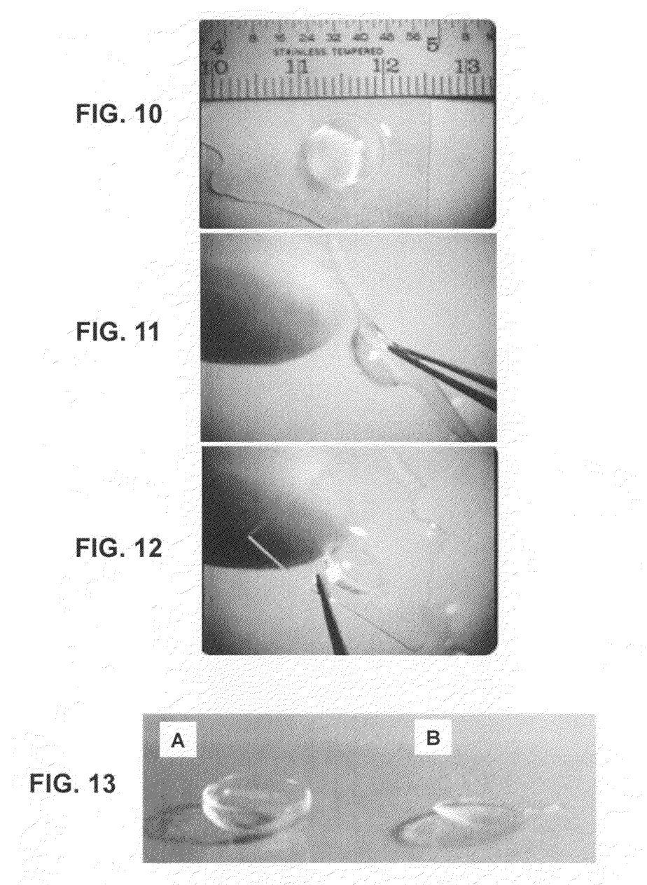

FIG. 6A shows an example of making a 3-D shaped IPN. In this example, a radially symmetric gradient photomask, as shown in FIG. 9A, can be used. The photomask is also illustrated by the radially outward shading in the box in FIG. 6A. The more shading, the less illumination passes through. In other words, the center of this mask allows the highest pass of UV, whereas the edges of the mask do not allow UV passage. A sheet of a polymerized first (e.g. PEG-based) network and a non-polymerized hydrogel solution (e.g. AA-based monomers) can be placed in between the glass plates. The function of the glass plates is to prevent oxygen, which can inhibit polymerization, from contacting the precursor solution. FIG. 6B shows the step of applying UV light through the radially symmetric gradient photomask, whereby polymerization of the second network occurs within the first network.

In one example, which is provided for exemplary purposes only and not to limit the scope of the invention, the light was delivered via a fiber optic and collimator whereby the front of the collimator is about 20 cm from the photomask. The diameter of the light bundle was approximately 7 cm (more than enough to illuminate the entire photomask in the example). The light source was a BlueWave 200 UV curing spot lamp (Dymax Corp.). A UV range from 300-500 nm with intense mercury peaks at 367, 406, 437 nm was used. The intensity will depend on how far away the light is from the sample. The exposure time in this example could range from 50-110 seconds, but is not limited to that range. Upon illumination and polymerization of the second network, AA monomers that did not polymerize are rinsed off. The resulting IPN hydrogel is then put in a hydrated state (e.g. by swelling to equilibrium in phosphate buffered saline pH 7.4). The differential swelling force of the second network within the first network generates the 3-D shaped IPN 100′ as shown in FIG. 6C.

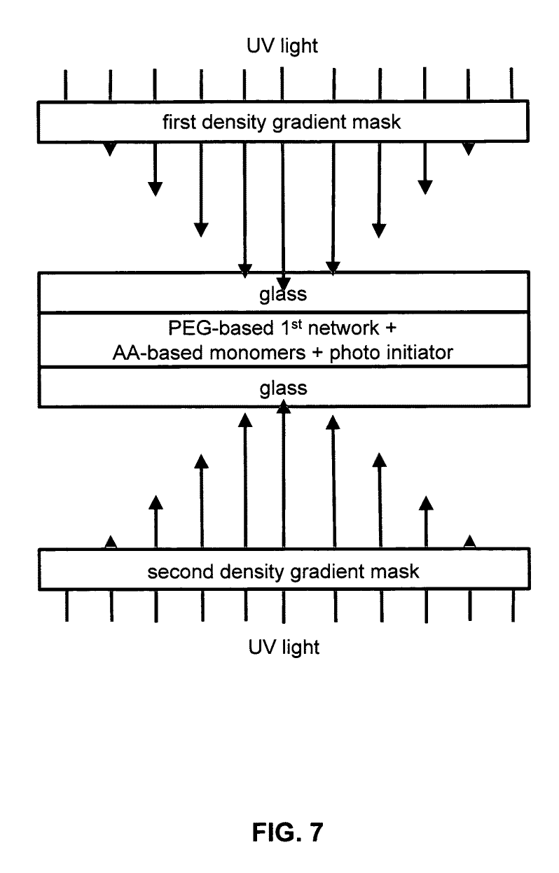

FIGS. 6A-C represent an example of one-sided illumination through a non-uniform photomask. FIG. 7 shows an example of a two-sided illumination using two non-uniform photomasks. The idea of using a two-sided illumination is to generate 3-D shape characteristics on two-sides of the IPN. This could be useful, for example, in applications where the use of the IPN is to focus or bend light. In other words, various one or two-sided non-uniform illumination patterns can be designed to develop e.g., but not limited to, biconvex, planar convex, convex/concave, biconcave, or planar concave IPNs (resp. FIG. 8A-E). The idea is that depending on the gradient of the photomask different 3-D shaped can be obtained. For example, convex/concave type shapes can be generated using a photomask where the highest/lowest illumination is in the center of the photomask and decreases/increases when moving away from the center. Commonly convex or concave surfaces of optical lenses are formed through molding, milling or lapping, which can be avoided when using the IPN lenses of this invention.

The precise shape of the gradient or non-uniform photomask and the density of the gradient/mask can be varied to generate 3-D shaped hydrogels with varying degrees of 3-D shapes and/or optical qualities. In addition, multiple illumination shapes could be present on a single mask (e.g. FIG. 9B) compared to a single mask (e.g FIG. 9A). The non-uniform illumination pattern or source that produces the pattern to form a 3-D shaped IPN could be varied in several ways, without departing from the spirit of the invention.

What is claimed is:

1. A three-dimensionally shaped interpenetrating double network hydrogel, comprising:
an entangled first network of poly(ethylene)glycol macromonomers, wherein said poly(ethylene)glycol macromonomers are linked to each other through end-groups of said poly(ethylene)glycol macromonomers,
wherein said entangled first network is physically interpenetrated with a second network, wherein said second network is based on crosslinked poly(acrylic) acids,
wherein said three-dimensional shaped interpenetrating double network hydrogel is characterized by changes in the radius of curvature, and wherein said changes in the radius of curvature correspond to a non-uniform distribution of the second network when in hydrated state.

2. The three-dimensionally shaped interpenetrating double network hydrogel as set forth in claim 1, wherein said changes in the radius of curvature correspond to a degree of non-uniformity of carboxylic acids in said second network.

3. The three-dimensionally shaped interpenetrating double network hydrogel as set forth in claim 1, wherein the changes in the radius of curvature of said three-dimensionally shaped interpenetrating double network hydrogel are either increasing or decreasing in a continuous fashion corresponding to the changes in distribution of said second network.

4. A method of making a three-dimensional shaped interpenetrating double network hydrogel, comprising:
(a) applying a non-uniform illumination pattern to polymerize a second network of monomers within a layer of a first network of entangled macromomers, wherein said non-uniform illumination pattern is applied to at least one side of said layer of said first network; and
(b) hydrating said second network after said second network is physically interpenetrating with said first network,
wherein said three-dimensional shaped interpenetrating double network hydrogel is characterized by changes in the radius of curvature, and wherein said changes in the radius of curvature correspond to said applied non-uniform illumination pattern.

5. The method as set forth in claim 4, wherein said changes in the radius of curvature correspond to a non-uniform distribution of the second network when in said hydrated state.

6. The method as set forth in claim 4, wherein said changes in the radius of curvature correspond to a degree of non-uniformity of carboxylic acids in said second network.

7. The method as set forth in claim 4, wherein said non-uniform illumination pattern is performed using a non-uniform photomask, a gradient photomask, or a radially symmetric gradient photomask.

8. The method as set forth in claim 4, wherein said step of non-uniform illumination is performed without the use of one or more molds for said layer of said first network for the purposes of making said three-dimensionally shaped interpenetrating double network hydrogel.
